(19) United States
(12) Patent Application Publication
(10) Pub. No.: US 2009/0153837 A1
(43) Pub. Date: Jun. 18, 2009

(54) OPTICAL POWER MONITOR BASED ON THERMO-CHROMIC MATERIAL

(75) Inventors: SEAN XIAOLU WANG, WILMINGTON, DE (US); BRIAN PRYOR, Newark, DE (US)

Correspondence Address: FRANK F. TIAN, 331-4A THIRD AVENUE, LONG BEACH, NJ, 07740, US

(73) Assignee: BWT PROPERTY, INC., Newark, DE (US)

(21) Appl. No.: 12/337,074

(22) Filed: Dec. 17, 2008

Related U.S. Application Data
(60) Provisional application No. 61/014,124, filed on Dec. 17, 2007.
(60) Provisional application No. 61/121,566, filed on Dec. 11, 2008.

(51) Int. Cl. G01J 5/02

(52) U.S. Cl. 356/43

(57) ABSTRACT

This invention relates to an optical power monitor based on thermo-chromic material. The incident light produces a temperature change in the thermo-chromic material, causing a change in its color which is utilized to monitor the power level of the incident light.

### REFERENCE TO RELATED APPLICATION

This application claims the inventions which were disclosed in Provisional Patent Application No. 61/014,124, filed Dec. 17, 2007, entitled “OPTICAL POWER MONITOR BASED ON LIQUID-CRYSTAL TEMPERATURE-SENSITIVE FILM” and Provisional Patent Application No. 61/121,566, filed Dec. 11, 2008, entitled “OPTICAL POWER MONITOR BASED ON THERMO-CHROMIC MATERIAL”. The benefit under 35 USC 119(e) of the above mentioned United States Provisional Applications is hereby claimed, and the aforementioned application is hereby incorporated herein by reference.

### FIELD OF THE INVENTION

This invention generally relates to an optical power monitor, and more specifically to an optical power monitor based on thermo-chromic material.

### BACKGROUND

Lasers or light emitting diodes (LEDs) have been widely used in medical and aesthetic applications such as general/special surgery, photo-biomodulation, pain-relief, wrinkle-reduction, tattoo removal, etc. In these applications, it is highly desirable for the practitioner to have a convenient means to monitor the power level, intensity distribution, and other optical properties of the laser light (especially for those infrared lasers that are invisible to the eye) to verify its effectiveness. Here the laser light may be directly emitted from the laser or be delivered through an optical system such as an optical fiber. However, these measurements are generally performed with high-cost analytical instruments such as optical power meters, optical beam profilers, etc. and it requires the practitioner to have certain optical knowledge to interpret the end result.

There thus exists a need for a convenient and easy to understand method to check and monitor the optical properties of a light beam such as a laser light. The method should require no high-cost analytical instruments and be capable of rendering an easy-to-read result for the practitioners or other users.

### SUMMARY OF THE INVENTION

There is provided a novel system and method for monitoring the power level and intensity distribution of a light beam using a thermo-chromic material.

A method for monitoring the power level and intensity distribution of a light beam is provided. The method comprising the steps of: providing a temperature-sensitive thermo-chromic material, wherein the thermo-chromic material can change color according to a change in temperature; causing the light beam to induce a temperature change and a corresponding color change in the thermo-chromic material, wherein the temperature change and the corresponding color change are related to the power level and intensity distribution of the light beam; and determining the power level and intensity distribution of the light beam through the color change of the thermo-chromic material.

A system for monitoring the power level and intensity distribution of a light beam is provided. The system comprising: a temperature-sensitive thermo-chromic material, wherein the thermo-chromic material can change color according to a change in temperature; means for causing the light beam to induce a temperature change and a corresponding color change in the thermo-chromic material, wherein the temperature change and the corresponding color change are related to the power level and intensity distribution of the light beam; and means for determining the power level and intensity distribution of the light beam through the color change of the thermo-chromic material.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one exemplary embodiment of the present invention, in which a liquid-crystal based thermo-chromic film is employed for monitoring the power level and intensity distribution of the light from a medical laser.

FIG. 2 shows another exemplary embodiment of the present invention, in which the power level and intensity distribution of a medical laser is measured with a dye crystal based thermo-chromic paper.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an optical power monitor based on thermo-chromic materials. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

A thermo-chromic material refers to a substance that can change its color according to a change in temperature. The thermo-chromic material can be made in the form of inks, paints, papers, etc. There are several types of thermo-chromic materials. One type is based on liquid-crystal, which can selectively reflect certain wavelengths by its crystallic structure. The color of the thermo-chromic liquid-crystal can change continuously from a non-reflective color (e.g. black) through the spectral colors to the non-reflective color (black) again, depending on the temperature. Another type of thermo-chromic material is made from dyes or metallic salts, such as those thermo-chromic papers used in thermal printers. The thermo-chromic paper can change its color, e.g. from white to black, when it is heated above certain temperature. It is also possible for the thermo-chromic paper to display multiple colors by employing several types of dyes or metallic salts with different temperature responses. The color-changing temperature of the available thermo-chromic material has a wide range. In the preferred embodiment of the present invention, this temperature is selected according to the power level of the medical laser.

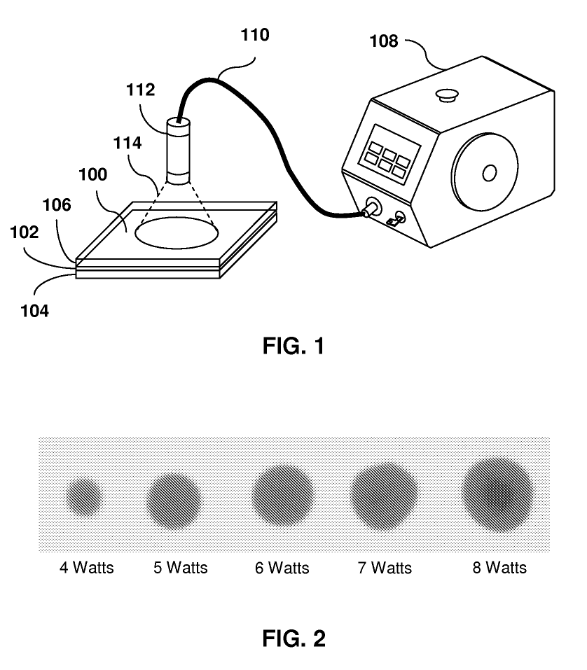

FIG. 1 illustrates one exemplary embodiment of the present invention, in which a liquid-crystal based thermo-chromic film 100 is used as an optical power monitor for monitoring the power level and intensity distribution of the light from a medical laser 108.

Referring to FIG. 1, the liquid-crystal based optical power monitor 100 comprises three laminated layers, i.e. a temperature-sensitive layer 102 interposed between a support layer 104, and an optional cover layer 106. The temperature-sensitive layer 102 is formed of cholesteric liquid-crystals, which are coated on top of the support layer 104. The liquid-crystal based temperature-sensitive layer 102 will change color, e.g. from black to red, yellow, green, and/or blue, according to a change in its temperature. The liquid-crystal based temperature-sensitive layer 102 can be adjusted through a manufacturing process to change colors over different temperature ranges. In this specific example, the liquid-crystal has a temperature sensitive range from 40° to 45° degree Celsius (° C.). The cover layer 106 is optional in the present embodiment. The cover layer 106 can be made of a transparent or semi-transparent material to allow light passage and in the meantime to protect the liquid-crystal temperature-sensitive layer 102 from contamination and mechanical damage.

Referring again to FIG. 1, the power level and intensity distribution of the therapeutic light 114 from a medical laser 108 is measured by the liquid-crystal based optical power monitor 100. The therapeutic light is delivered through an optical fiber 110 and an output wand 112 to form an output light beam 114. When the light beam 114 illuminates the power monitor 100 through the optional cover layer 106, a portion of the light energy is absorbed by the cover layer 106, the liquid-crystal layer 102, and/or the support layer 104 and then converted into heat, thereby causing a temperature rise in the liquid-crystal layer 102. The temperature rise during a fixed period of time is proportional to the heat produced by the light beam, which in turn is proportional to its power level. Such a temperature rise causes changes in the color of the liquid-crystal layer 102, thereby allowing the practitioner or the user to check the power level of the therapeutic light through this easily-observable color change. The heat capacity and thermal conductivity of the liquid-crystal layer 102, the support layer 104, and the cover layer 106 can be designed by adjusting their physical dimension and/or material composition such that a desired temperature rise matching with the temperature range of the liquid-crystal material is produced when the incident light possesses certain power level.

The size of this liquid-crystal based power monitor 100 can be made to cover the whole cross-section of a laser beam, thus allowing the practitioner to monitor the intensity distribution of the laser beam as well. For example, at areas where the light intensities are higher, larger temperature rises will be produced, making the color of the liquid-crystal more bluish. While for areas with low light intensities, more reddish colors will be produced. As a result, the intensity distribution of the light beam can be determined from the spatial distribution of the color change of the liquid-crystal layer 102. This intensity distribution or beam profile measurement allows the practitioner to check the quality of the laser beam.

In a first variation of the present embodiment, the light beam 114 can illuminate from the support layer 104 in stead of from the cover layer 106. This scheme is more preferred for an incident light beam having a high peak power, such as the light produced by a pulsed laser. In this case, the support layer 104 is made of a light absorbing material with high optical damage threshold which can withstand the high peak power of the incident light. The temperature rise of the support layer 104 is transmitted to the liquid-crystal layer 102 through thermal conduction, causing a color change which reflects the power level of the incident light.

In a second variation of the present embodiment, the support layer 104 and/or cover layer 106 of the power monitor 100 can be made of a phase change material (PCM), such as wax, which changes its phase, e.g. solid-to-liquid, liquid-to-gas, solid-to-gas, etc. at the temperature-sensitive range of the liquid-crystal. This PCM possesses a large latent heat which helps to maintain the temperature of the liquid-crystal layer 102 and therefore causing the liquid-crystal layer 102 to produce a more stable color variation. In certain cases, this PCM layer can be utilized to limit the usage times of the liquid-crystal power monitor.

FIG. 2 shows another exemplary embodiment of the present invention, in which the power level and intensity distribution of a medical laser is measured with a dye crystal based thermo-chromic paper. Similar to that shown in FIG. 1, when the thermo-chromic paper is illuminated with the laser beam, portion of the light energy is absorbed by the thermo-chromic paper and then converted into heat, causing a temperature rise in the thermo-chromic paper. The intensity distribution of the laser beam is reflected by the color gradient of the illuminated thermo-chromic paper. In this specific example, the medical laser is a 980 nm near-infrared (NIR) high power diode laser with adjustable output power. The thermo-chromic paper, which is embedded with several types of dye crystals, can display multiple colors depending on the magnitude and duration of its temperature rise. The thermo-chromic paper is illuminated with the laser light for a time duration of 10 sec. The power of the laser is adjusted from 4 watts to 8 watts at 1 watt step.

Referring again to FIG. 2, the size and color of the laser induced spot that is displayed on the thermo-chromic paper clearly indicate the power level and intensity distribution of the corresponding laser beam, where the laser beam with higher power level produces a larger spot with darker color in the center. Any abnormality in the intensity distribution of the laser beam will be reflected by a change in the shape and color of the laser induced spot. Thus the intensity distribution of the light beam can be determined from the spatial distribution of the color change of the thermo-chromic paper. In a slight variation of the present embodiment, the thermo-chromic paper may be laminated with other materials to achieve the desired heat capacity and thermal conductivity.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for monitoring the power level and intensity distribution of a light beam, the method comprising the steps of:
providing a temperature-sensitive thermo-chromic material, wherein the thermo-chromic material can change color according to a change in temperature;
causing the light beam to induce a temperature change and a corresponding color change in the thermo-chromic material, wherein the temperature change and the corresponding color change are related to the power level and intensity distribution of the light beam; and
determining the power level and intensity distribution of the light beam through the color change of the thermo-chromic material.

2. The method of claim 1, wherein the thermo-chromic material is capable of displaying a plurality of colors with each color associated with a specific temperature.

3. The method of claim 1, wherein the intensity distribution of the light beam is determined from a spatial distribution of the color change of the thermo-chromic material.

4. The method of claim 1, wherein the temperature change is induced by directly illuminating the thermo-chromic material with the light beam.

5. The method of claim 1, further comprising a step of laminating the thermo-chromic material with a light absorbing material.

6. The method of claim 5, wherein the temperature change is induced by illuminating the light-absorbing material with the light beam and causing the temperature change of the light-absorbing material to be transmitted to the thermo-chromic material.

7. The method of claim 1, further comprising a step of laminating the thermo-chromic material with a phase change material.

8. The method of claim 7, wherein the temperature change causes the phase change material to change phase.

9. The method of claim 1, wherein the thermo-chromic material is selected from a liquid-crystal material, a dye material, and/or a metallic salt material.

10. A system for monitoring the power level and intensity distribution of a light beam, the system comprising:
a temperature-sensitive thermo-chromic material, wherein the thermo-chromic material can change color according to a change in temperature;
means for causing the light beam to induce a temperature change and a corresponding color change in the thermo-chromic material, wherein the temperature change and the corresponding color change are related to the power level and intensity distribution of the light beam; and
means for determining the power level and intensity distribution of the light beam through the color change of the thermo-chromic material.

11. The system of claim 10, wherein the thermo-chromic material is capable of displaying a plurality of colors with each color associated with a specific temperature.

12. The system of claim 10, wherein the intensity distribution of the light beam is determined from a spatial distribution of the color change of the thermo-chromic material.

13. The system of claim 10, wherein the temperature change is induced by directly illuminating the thermo-chromic material with the light beam.

14. The system of claim 10, further comprising means for laminating the thermo-chromic material with a light absorbing material.

15. The system of claim 14, wherein the temperature change is induced by illuminating the light-absorbing material with the light beam and causing the temperature change of the light-absorbing material to be transmitted to the thermo-chromic material.

16. The system of claim 10, further comprising means for laminating the thermo-chromic material with a phase change material.

17. The system of claim 16, wherein the temperature change causes the phase change material to change phase.

18. The system of claim 10, wherein the thermo-chromic material is selected from a liquid-crystal material, a dye material, and/or a metallic salt material.
